(19) United States
(12) Patent Application Publication
(10) Pub. No.: US 2003/0007901 A1
(43) Pub. Date: Jan. 9, 2003

(54) Method and system for reduction of NOx in automotive vehicle exhaust systems

(76) Inventors: John Hoard, Livonia, MI (US); Mari Lou Balmer-Millar, Chillicothe, IL (US); Russell G. Tonkyn, Kennewick, WA (US); Alexandre Malkine, St-Petersburg (RU); Alexander Panov, Richland, WA (US)

Correspondence Address: Scott A. Chapple, Dobrusin Darden Thennisch & Lorenz PC, Suite 311, 401 South Old Woodward Avenue, Birmingham, MI, 48009, US

(21) Appl. No.: 09/897,073

(22) Filed: Jul. 3, 2001

(51) Int. Cl. B01D 50/00

(52) U.S. Cl. 422/171; 422/169; 422/172; 422/177; 422/180; 422/188; 422/189; 422/190; 422/191; 422/193; 422/211; 422/221; 422/222; 60/275; 60/282; 60/299

(57) ABSTRACT

A method and system for reducing the amount of NOₓ in an automotive vehicle combustion exhaust gas are disclosed. Accordingly, the system includes a first converter for forming aldehyde in a tributary fluid that includes fuel from the fuel tank of an automotive vehicle. Once the aldehyde is formed, the tributary fluid is combined with combustion exhaust of the vehicle to form an aldehyde/exhaust admixture. Thereafter, a second converter of the system is used to reduce NOₓ in the aldehyde/exhaust admixture to N₂ gas and O₂ gas.

### TECHNICAL FIELD

The present invention relates to the reduction of NOₓ in exhaust gas of automotive vehicles to nitrogen gas (N₂) and oxygen gas (O₂).

### BACKGROUND OF THE INVENTION

Generally, an automotive vehicle includes a combustion engine that burns fuel and emits combustion exhaust gas containing nitrogen oxide (NOₓ) gas. The art continues to investigate ways to efficiently convert or reduce the NOₓ in the exhaust gas into nitrogen gas (N₂) and oxygen gas (O₂) before the exhaust gas is emitted from the vehicle. Methods of reducing NOₓ are disclosed in PCT publication WO 00/18494 related to U.S. patent application Ser. No. 09/164,874, both titled Catalytic Plasma Reduction of NOₓ, both of which are herein fully incorporated by reference. The present invention seeks to provide an improved method and system for reducing NOₓ in exhaust gas to N₂ and O₂.

### SUMMARY OF THE INVENTION

Accordingly, there is provided an exhaust system and a method for reducing the amount of NOₓ in a combustion exhaust gas of an automotive vehicle. The system includes a fuel supply vessel for supplying fuel to an engine of the automotive vehicle for combustion, and to a fuel mixing site for providing a tributary fluid admixture including fuel and oxygen. The system also includes a first converter including means for forming an aldehyde from at least a portion of the tributary fluid. An exhaust tube is adapted for receiving the combustion exhaust from the engine, and for combining the combustion exhaust with the aldehyde to form an aldehyde/exhaust admixture. A second converter of the system includes a catalyst for reducing NOₓ present in the aldehyde/exhaust admixture to N₂ and O₂.

According to the method, a tributary gas admixture including fuel and oxygen is provided. An aldehyde is formed from the admixture. The aldehyde is mixed with a combustion exhaust from an engine of an automotive vehicle to form an aldehyde/exhaust admixture. The aldehyde/exhaust admixture is flowed over a catalyst for reducing NOₓ to N₂ and O₂.

### BRIEF DESCRIPTION OF THE DRAWINGS

These and other objects, features, aspects, and advantages of the invention will become apparent upon consideration of the specification and appended drawings in which:

FIG. 1 is a diagram of an exhaust system for reducing the amount of NOₓ in combustion exhaust gas of an automotive vehicle

FIG. 2 illustrates a side sectional view of a converter for converting hydrocarbons to aldehydes.

FIG. 3 illustrates a side sectional view of a converter for reducing NOₓ into N₂ and O₂.

FIG. 4 illustrates a side partial cut away view of a reactor for converting hydrocarbons to aldehydes.

FIG. 5 illustrates a perspective partially exploded view of a reactor for converting hydrocarbons to aldehydes.

### DESCRIPTION OF PREFERRED EMBODIMENT

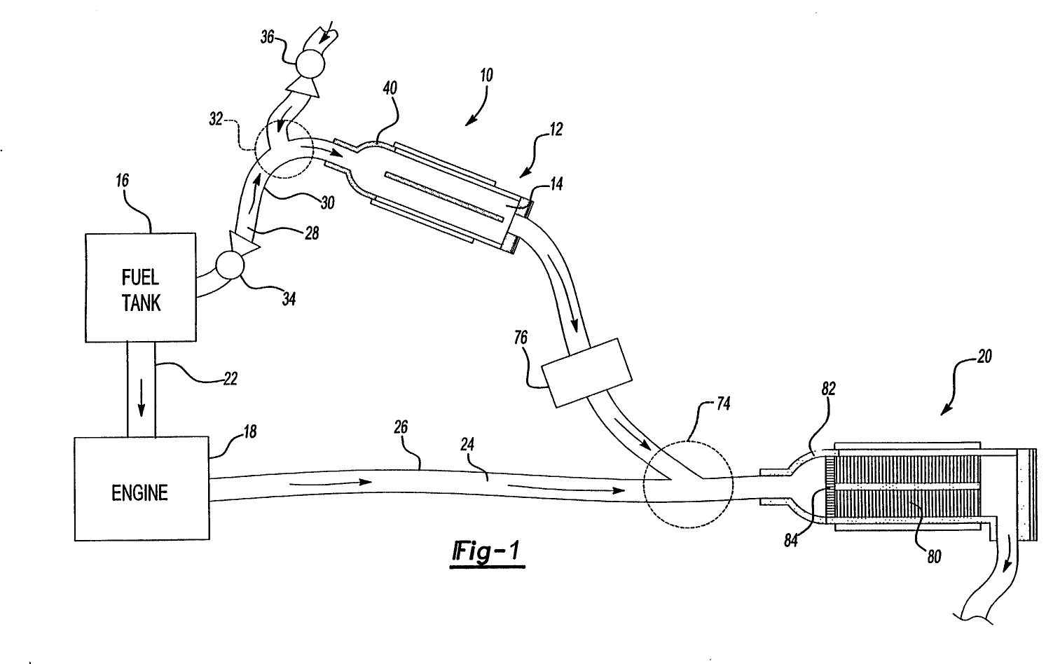

Referring to FIG. 1, there is illustrated an exhaust system 10 for reducing the amount of nitrogen oxide (NOₓ) in a combustion exhaust gas of an automotive vehicle. The system 10 generally includes a first converter 12 having a suitable mechanism 14 for converting hydrocarbon fuel from a fuel supply 16 into an aldehyde. Thereafter, the aldehyde is combined with exhaust gas from a combustion engine 18 such that NOₓ in the exhaust gas can be reduced to nitrogen gas (N₂) and oxygen gas (O₂) using a second converter 20.

In the system 10, fuel from the fuel supply vessel 16 (e.g., an automotive fuel tank) flows to the engine 18 through a fuel supply line 22. The engine 18 burns the fuel, thus forming exhaust gas that flows through a passageway 24 of an exhaust tube 26 such that the exhaust gas can be purged from the vehicle. A controller (not shown) or other suitable device typically signals the amount of fuel supplied to the engine 18 in response to depression of a gas pedal, and taking into account other engine and vehicle operating conditions.

Upon supply of fuel to the engine, the present system contemplates that fuel also flows from the fuel supply 16 through a passageway 28 of a tributary tube 30. The fuel is combined with oxygen gas (O₂) (e.g., from air) at a fuel mixing site 32 to form a tributary fluid admixture, preferably in a gaseous state. The admixture is then supplied to the first converter 12. Suitable fluid pumps 34, 36 assist in supplying gas and air to the first converter 12. The amount of fuel and oxygen supplied to the converter 12 is in turn controlled by a controller in communication with the pumps 34, 36. The resulting tributary fluid admixture flows through the first converter 12 where it is reacted or otherwise treated to form an aldehyde. Preferably, the tributary fluid then includes one or more aldehydes such as acetaldehyde, propionaldehyde, butyraldehyde, other higher order aldehydes or combinations thereof.

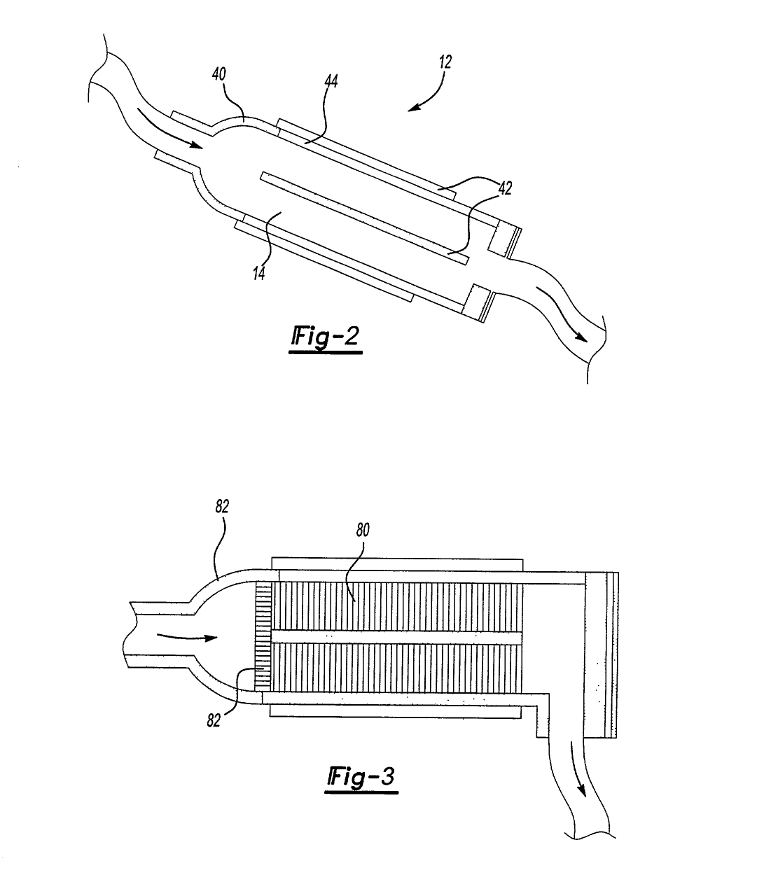

By way of illustration, the tributary fluid admixture can be converted to an aldehyde by a plasma treatment. For instance, referring to FIGS. 1 and 2, the converter 12 may include a plasma generator for forming non-thermal or non-equilibrium plasma 14 within a chamber 40 such as a dielectric barrier plasma 14. The plasma generator generally includes electrodes 42 connected to an electrical power source and, if needed or desired, a dielectric glass or ceramic (e.g., alumina) barrier 44.

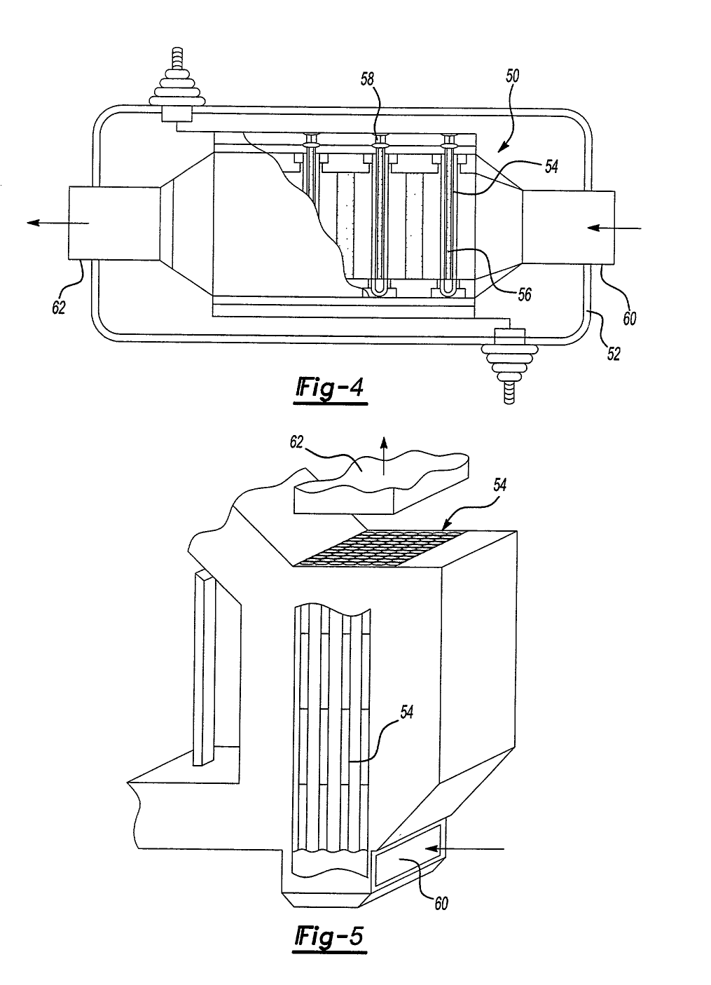

One such plasma chamber 40 includes a packed bed reactor for forming the plasma 14. Alternatively, it includes a tube array reactor for forming the plasma 14, where lower energy requirements are desired. In FIG. 4, there is shown a tube array reactor 50 encased in a metallic housing 52. Dielectric tubes 54 are metallized on the inside 56 and electrified by fused contacts 58 to a high voltage power source (not shown). In this tube array design, the tributary gas enters the chamber inlet 60 and flows in a transverse direction across the dielectric tubes 54 before exiting the chamber outlet 62.

In another alternate exemplary configuration shown in FIG. 5, (from U.S. Pat. No. 5,458,748 titled, “Coronal-Catalytic Apparatus and Method for NOₓ Reduction” to Breault et al. incorporated by reference herein), the exhaust gas stream enters the chamber inlet 60 and flows through the tubes 54 in a parallel direction with the tubes 54 before exiting the chamber outlet 62.

Referring again to FIG. 1, the tributary fluid with the aldehyde exits the chamber 40 and flows through the remainder of the tributary tube 30 to a mixing location 74. At the mixing location 74, the tributary fluid flows into the passageway 24 of the exhaust tube 26 to combine with the combustion exhaust and form an aldehyde/exhaust admixture.

In operation, it is contemplated that variable amounts of combustion gas will be produced by the vehicle. Preferably, the amount, rate or both of aldehyde in the tributary fluid flowing to the mixing location 74 is controlled to correspond with the amount, rate or both of exhaust gas flowing to the mixing location 74. It shall be recognized that various timing measures may be taken to assure that enough aldehyde is provided to the mixing location 74 as different amounts of combustion exhaust flow to the mixing location 74. For example, one or more controllers can supply fuel to the first converter 12 in proportion to the fuel supplied to the engine 18. Additionally, a suitable controller can alter the timing of supplying fuel to the first converter 12 and the engine 18 to assure that proper amounts of aldehyde arrive at the mixing location 74 in correspondence to amounts of exhaust gas arriving at the mixing location 74.

Alternatively, a receptacle 76 may be used to assist in timing delivery of aldehyde to the mixing location 74. The receptacle 76 may be configured to receive tributary fluid containing the aldehyde from the converter 12 and store the tributary fluid until needed. Thereafter, the stored tributary fluid can be delivered to the exhaust as needed by a pump (not shown) controlled by an associated controller. Advantageously, the same or a different controller can be configured to command delivery of the tributary fluid from the converter 12 to the receptacle 76 primarily during vehicle deceleration. Thus, vehicle inertia could provide power to an electrical generation system of the vehicle, which, in turn, could provide power to the plasma 14 of the converter 12 thereby utilizing power that might otherwise be purged.

Also advantageous, the first converter 12 can be positioned or insulated relative to the exhaust tube 26, such that vibration or other harsh forces that are typically experienced by an exhaust tube during vehicle operation are not also imposed on the converter 12, receptacle 76 or both. Preferably, a portion of the tributary tube 30 is formed of a suitable flexible material to further insulate or dampen the first converter 12, the receptacle 76 or both relative to harsh forces.

Referring to FIGS. 1 and 3, the aldehyde exhaust admixture flows to the second converter 20, which includes a suitable catalyst 80 (e.g. a microporous catalyst) for catalyzing the reduction of NOₓ that is present in the aldehyde/exhaust admixture to N₂ and O₂. As shown, the catalyst 80 is supported within a catalyst chamber 82 through which the exhaust flows. AS an example, the catalyst may be at least partially supported by a suitable frit 84 or other support.

One preferred microporous catalyst is a zeolite, and more particularly a zeolite in the class of metallic Faujasites, Linde Type A (LTA). Preferably, the catalyst is substantially entirely microporous, and has a mean pore size of no greater than about 15 angstroms. In some applications, the catalyst may include mesopores greater than about 15 angstrom, or a combination of micropores and mesopores.

The metallic Faujasite is preferably crystalline. One preferred catalyst has a structure selected from the group of zeolite X, zeolite Y and combinations thereof. The catalyst may include aluminosilicate, titanosilicate, or both. Other network site cations may include iron, gallium, germanium and combinations thereof.

The metal in the exchange site of the metallic Faujasite may be alkali, such as Mg, Li, Na, K, Rb, Cs, alkali earth, such as Ca, Sr, Ba, transition metals such as Sc, Y, Ti, Zr, Hf, V, Nb, Ta, Cr, Mo, W, Mn, Tc, Re, Fe, Ru, Os, Co, Rh, Os, Co, Rh, Ir, Ni, Pd, Pt, Cu, Ag, Au, rare earths or combinations thereof. Rare earths include, but are not limited to Ce and Sm. The amount of metal atoms in the metallic Faujasite ranges from about 5% to about 100% of available sites for metal atoms. The metallic Faujasite has a micropore size of at least 6 angstrom units. Generally, zeolite Y has a pore size of about 7 angstroms and zeolite X has a pore size of about 10 angstroms.

The catalyst is capable of converting up to or more than 55% of NOₓ to N₂ at a temperature of about 150° C. to about 250° C., and more preferably about 180° C. This makes its use attractive for diesel exhaust applications that operate near 150° C. to 200° C. as well as for other standard exhaust applications.

A free aperture size greater than about 3.5 angstrom units is preferably employed to permit flow of unburned hydrocarbon into the pores of the catalyst during conversion, while generally preventing the formation of nitric acid. A free aperture size greater than 6 angstrom units is even more preferred.

The catalyst may be packed or otherwise disposed as a perforated or porous monlith, beads, powder or combination thereof.

Zeolites of Linde Type A (LTA) may be characterized by pore sizes on the order of 4 angstroms or better. Small cations, including but not limited to Li, Na, Ca and combinations thereof permit NOₓ conversion to N₂. Large cations, for example K may fill pores preventing entrance of unburned hydrocarbons and reduce conversion.

Of course, other microporous materials with structures different from Faujasite or Type A including titanosilicate (ETS-10) templated mesoporous materials with micropores have also been found useful for NOₓ conversion to N₂ and are thus contemplated as within the scope of useful catalysts for the present invention.

Once at least a portion of the NOₓ in the exhaust gas has been reduced to N₂ and O₂, the exhaust is purged from the vehicle.

Referring again to FIGS. 1 and 3, alternative embodiments of the system 10 may include a catalyst 14 or catalyst/plasma combination 14 as the mechanism 14 for forming aldehyde in the converter 12. The catalyst 14 may be a metal oxide catalyst, (e.g., tungsten or vanadium oxides (W₂O₃, V₂O₅)) or a noble metal, such as platinum supported on alumina (Pt—Al₂O₃). Such catalysts may be heated to about 180° C. with a heater associated with the converter 12.

In still other alternative embodiments, the first converter 12 and second converter 20 may be integrated into a single vessel or within a single housing. The first converter 12 may be adapted for receiving at least a portion of the combustion exhaust upstream of the forming means 14 such as by using the pump 36 to divert exhaust gas to the passageway 28 thereby supplying oxygen to the converter 12. The pump supplying fuel to the converter 12 may be the same as a pump (not shown) used to supply fuel to the engine 18 if a portion of the fuel flowing to the engine is diverted into the converter 12. One controller or a plurality of controllers may be used to control flow of fuel to the engine 18, control flow of fuel to the converter 12 and control flow of aldehyde from the receptacle 76 to the mixing location 74.

Advantageously, for helping to minimize fuel consumption, the amount of fuel used in connection with the tributary fluid may be relatively small compared to the fuel delivered to the engine of the vehicle (e.g., volumes of fuel supplied for the tributary fluid may be about 0.1% to about 5% and more preferably about 1% to about 2% of the volume of fuel supplied engine). Thus, when the converter 12 is a plasma, the plasma may be relatively small and typically requires relatively low amounts of electrical energy for forming sufficient amounts of aldehyde. Alternatively, if a catalyst is used, relatively small amounts of catalyst may be required for forming sufficient amounts of aldehyde.

It should be understood that the invention is not limited to the exact embodiment or construction, which has been illustrated and described but that various changes may be made without departing from the spirit and the scope of the invention.

What is claimed is:

1. An exhaust system for reducing the amount of NOₓ in a combustion exhaust gas of an automotive vehicle, said system comprising:
(a) a fuel supply vessel for supplying fuel to
i) an engine of said automotive vehicle for combustion; and
ii) a fuel mixing site for providing a tributary fluid admixture including fuel and oxygen
(b) a first converter including means for forming an aldehyde from at least a portion of said tributary fluid;
(c) an exhaust tube adapted for
i) receiving said combustion exhaust from said engine; and
ii) combining said combustion exhaust with said aldehyde to form an aldehyde/exhaust admixture
(d) a second converter including a catalyst for reducing NOₓ present in said aldehyde/exhaust admixture to N₂ and O₂.

2. A system as in claim 1 wherein at least a portion of said aldehyde is acetaldehyde.

3. A system as in claim 1 wherein at least a portion of said aldehyde is an aldehyde of a higher order than acetaldehyde.

4. A system as in claim 1 wherein said first converter includes a plasma generator for forming said aldehyde.

5. A system as in claim 4 wherein said plasma generator produces a dielectric barrier plasma.

6. A system as in claim 1 wherein said first converter includes a catalyst for converting said fuel in said tributary fluid into said aldehyde.

7. A system as in claim 1 wherein said first converter and said second converter are integrated in a single vessel.

8. A system as in claim 1 wherein said zeolite catalyst is a zeolite catalyst chosen from the group consisting of metallic Faujasite, Linde Type A and combinations thereof.

9. A system as in claim 1, further comprising a receptacle for storage of aldehyde containing tributary fluid prior to combining the tributary fluid with the exhaust.

10. A system as in claim 1 wherein said first converter is adapted for receiving at least a portion of said combustion exhaust upstream of said forming means.

11. A method for reducing the amount of NOₓ in exhaust gas of an automotive vehicle, said automotive vehicle having a fuel tank for supplying fuel to an engine of said vehicle, said method comprising:
(a) providing a tributary gas admixture including fuel and oxygen;
(b) forming an aldehyde from said admixture;
(c) mixing said aldehyde with a combustion exhaust from said engine to form an aldehyde/exhaust admixture;
(d) flowing said aldehyde/exhaust admixture over a catalyst for reducing said NOₓ to N₂ and O₂.

12. A method as in claim 11 wherein at least of portion of said aldehyde is acetaldehyde.

13. A method as in claim 11 wherein at least a portion of said aldehyde is an aldehyde of a higher order than acetaldehyde.

14. A method as in claim 11 wherein said forming step (b) includes generating a plasma.

15. A method as in claim 14 wherein said forming step (b) includes generating a dielectric barrier plasma.

16. A method as in claim 11 wherein forming step (b) includes converting said fuel to an aldehyde in the presence of a catalyst.

17. A method as in claim 11 wherein said forming step (b) and said flowing step (d) occur within a single vessel.

18. A method as in claim 11 wherein said catalyst is a zeolite chosen from the group consisting of metallic Faujasite, Linde Type A and combinations thereof.

19. A method as in claim 11 further comprising storing said aldehyde in a receptacle prior to said mixing step (c).

20. A method as in claim 11 wherein said tributary gas admixture includes a combustion exhaust gas.
